(19) United States
(12) Patent Application Publication
(10) Pub. No.: US 2007/0221266 A1
(43) Pub. Date: Sep. 27, 2007

(54) Solar roof tile

(76) Inventors: Dan Gower Davies, Bath (GB); Martyn John Charles Berry, (US); Ian Jonathan Kenyon, (US)

Correspondence Address: FAY SHARPE LLP, 1100 SUPERIOR AVENUE, SEVENTH FLOOR, CLEVELAND, OH, 44114, US

(21) Appl. No.: 11/711,522

(22) Filed: Feb. 27, 2007

(30) Foreign Application Priority Data
Feb. 28, 2006 (GB) GB 0604002.6

(51) Int. Cl. H02N 6/00

(52) U.S. Cl. 136/244

(57) ABSTRACT

A solar roof tile comprising an elongate unit whose length is a multiple of the length of a standard roof tile so that it may be substituted for a corresponding number of such tiles, and comprises an elongate trough-shaped member which is adapted to house a heat exchanger including fluid conduits, and a co-operating cover-plate which includes an aperture adapted to receive a transparent cover for the trough-shaped member, or a photovoltaic collector.

This invention relates to solar roofing systems, and in particular to a tile structure for solar roofs. The present invention relates particularly to a solar tile structure which is moulded from a plastics material, such as polycarbonate, and is adaptable for use in solar roof systems which collect energy from photovoltaic elements, solar thermal collectors, or a combination of both.

One example of a solar tile is disclosed in international application no. WO05045328 which comprises a solar tile including a transparent window portion, and a heating space below the window portion, the tile being formed with protrusions along each side edge which are adapted to interlock with adjacent tiles of a known conventional type.

A first aspect of the present invention provides a solar roof tile comprising an elongate unit whose length is a multiple of the length of a standard roof tile, so that it may be substituted for a corresponding number of roof tiles, and comprises an elongate trough-shaped member adapted to house a heat exchanger including fluid conduits, and a cover-plate with an aperture adapted to receive a transparent cover for the trough-shaped member, or carrying a photovoltaic collector. In a preferred embodiment of the invention the tile is formed in two parts, comprising a cover-plate with an aperture, and a trough member which can be assembled on to the rear of the cover-plate beneath the aperture. The trough member is adapted to receive a heat exchanger. The cover-plate can also be used as a “stand-alone” photovoltaic tile or roof window when a solar thermal collector is not required.

Alternatively, the trough member and the cover-plate may be integrally moulded, the trough member including a formation of ledges or protrusions, along its side walls at a depth intermediate between the base and the cover-plate, which are adapted to locate a thermal collector plate, whose undersurface carries conduits for heat exchange fluid. In this way, the assembly of the device can be facilitated, by sliding the collector plate into position from one end.

Once again, if the solar thermal collector feature is not required the collector plate can simply be omitted.

In either case, the front section of the outer surface of the cover-plate is preferably sloped in towards the trough region, so that when the tile is mounted in a conventional sloping position on a roof, the internal collector plate is subjected to a minimum of shade from the cover-plate, particularly when the sun is at a low angle. This is especially important, if the space between the front window, and the collector plate, is kept to at least 20 mm, to minimise heat losses through the front cover-plate.

Preferably, the collector plate is formed as a roll-bonded sheet aluminium structure, incorporating integral waterways so as to increase efficiency.

Preferably, when the device is constructed as a rigid moulding in plastics material, the front and rear edges of the cover plate are formed with downwardly dependent flanges and the internal rear surface is also formed with ribs which act to strengthen the entire structure. In order to provide ventilation inside the structure and to avoid condensation collecting, a series of gaps are preferably provided along the free edges of the ribs and the flanges, which are so arranged as to allow air to circulate through the internal compartments formed by the combination of the ridges and flanges, when the tile is installed in contact with an underlying surface such as that of another tile.

The lower and optionally, upper edges may also be formed with a. series of mouldings mimicking joints at spacings corresponding to the width of one standard tile, as a guide to roofers when installing adjacent levels of conventional tiles. These may also incorporate the above-mentioned air gaps.

The device is designed to fit in with standard 420 H×330 W roof tiles. Typically the cover-width of the device will be equivalent to an assembly of four standard-size tiles fitted in a row, that is to say about 1170 mm.

Preferably, the structure incorporates high performing insulation such as silica aerogel, phenolic foam or the like, so as to maintain good performance in a relatively slim profile.

Preferably, the tiles are pre-assembled in pairs, with a hinge arrangement such as a strip of flexible material connecting the pair of tiles by their shorter edges, i.e. in an end-to-end configuration. This enables each pair to be transported in a folded together condition, and to incorporate connections between them which are made in a controlled environment rather than during the installation process. Since a typical installation will comprise a number of such pairs, arranged at successive levels of the roof surface, this allows the number of connections to be made to the thermal circuits, to be kept down to a single pair at each level, even though each level comprises two multi-tile width panels.

Preferably, pre-assembled manifolds are also provided so as to connect the end of each assembly with an in-house solar thermal system. This reduces the time required for on-site plumbing work.

Preferably, each tile incorporates formations corresponding to the nibs at the rear edge of a conventional tile to locate it onto a roofing batten in a conventional manner, and also comprises an overlap and underlap detail at each end, comprising a series of ridges and grooves which will interlock with corresponding formations on tiles made by a number of leading manufacturers. Preferably, these formations are sized so as to fit with as many different tile types as possible, with the grooves large enough to accommodate the largest possible ridges on an adjacent tile, and the ridges small enough to fit in the smallest grooves which are likely to be encountered in practice.

Preferably, each tile is formed with a number of preformed screw holes which are arranged for attachment to a batten in a conventional manner, but are moulded as “blind” holes closed off by a thin biscuit of material which can be easily pierced by a screw in use. This ensures that the tile remains weatherproof, even if not all the holes re used on installation.

When the structure forms part of a thermal system, it may also be arranged to provide space heating or solar cooling, by connecting suitable ancillary systems either directly or indirectly to the tiles.

The tile cover-plate member may also be incorporated in a roof without either a photovoltaic or a thermal heat collection device, but with plain glass or other transparent material in the front aperture so as to provide a roof window or a collector window for a light pipe. In this way, a roof may be constructed from a number of interlocking elements, some of which provide solar energy gathering capability of different types, and some of which simply provide internal lighting.

Some embodiments of the invention will now be described by way of example with reference to the accompanying drawings, in which:

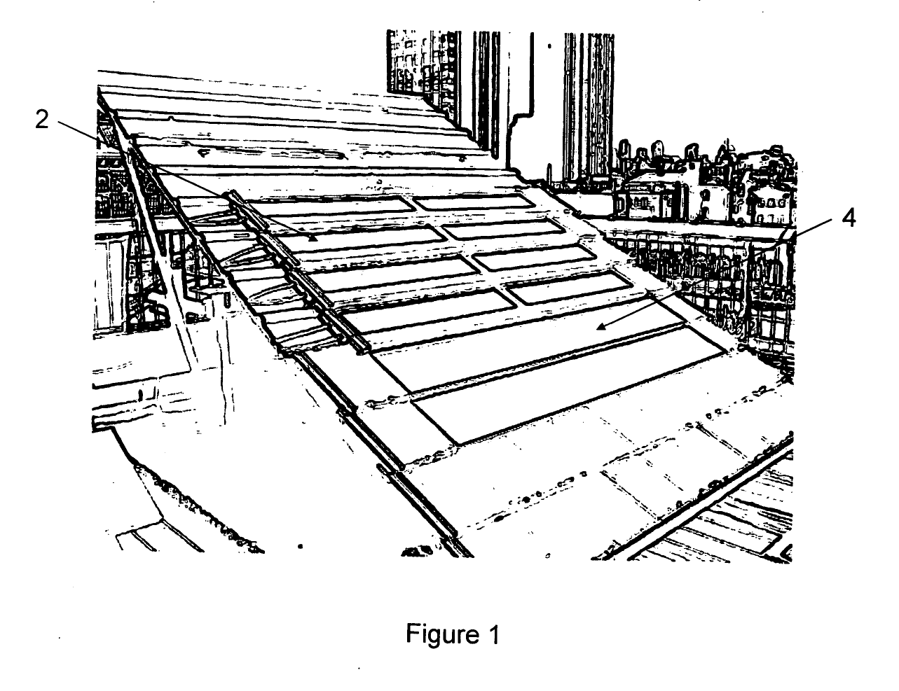

FIG. 1 is a perspective view of a section of roof including different levels of solar tiles;

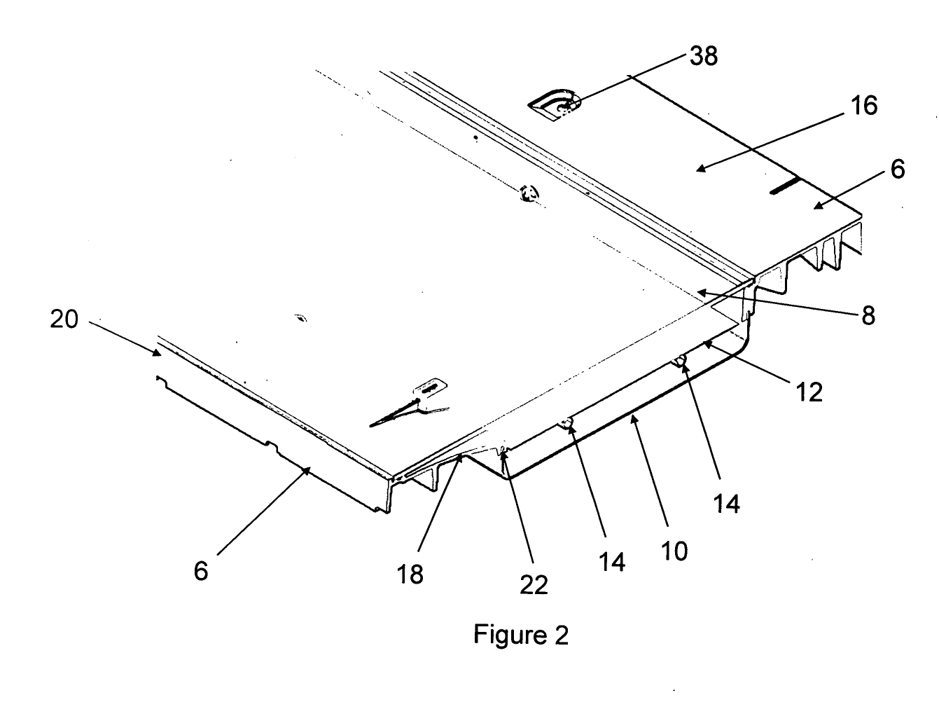

FIG. 2 is a cross section through a solar tile according to the present invention;

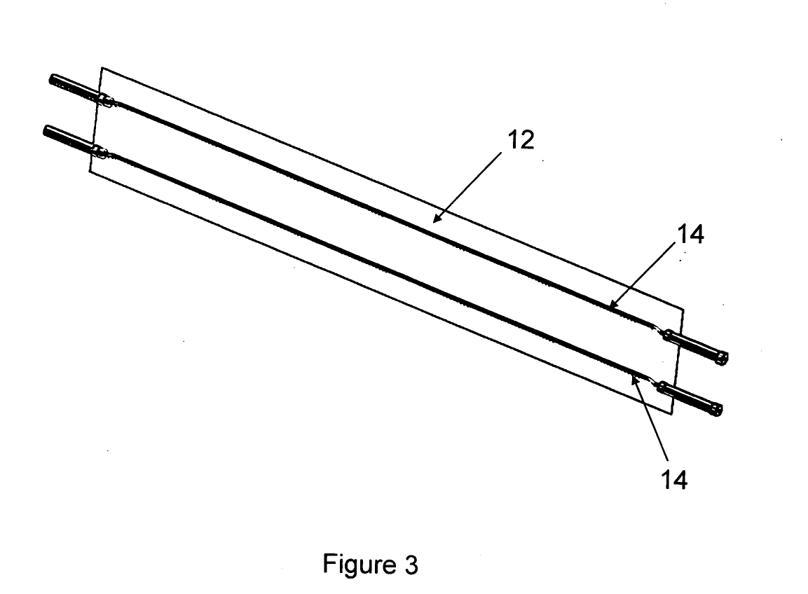

FIG. 3 is a rear view of a solar thermal collector plate;

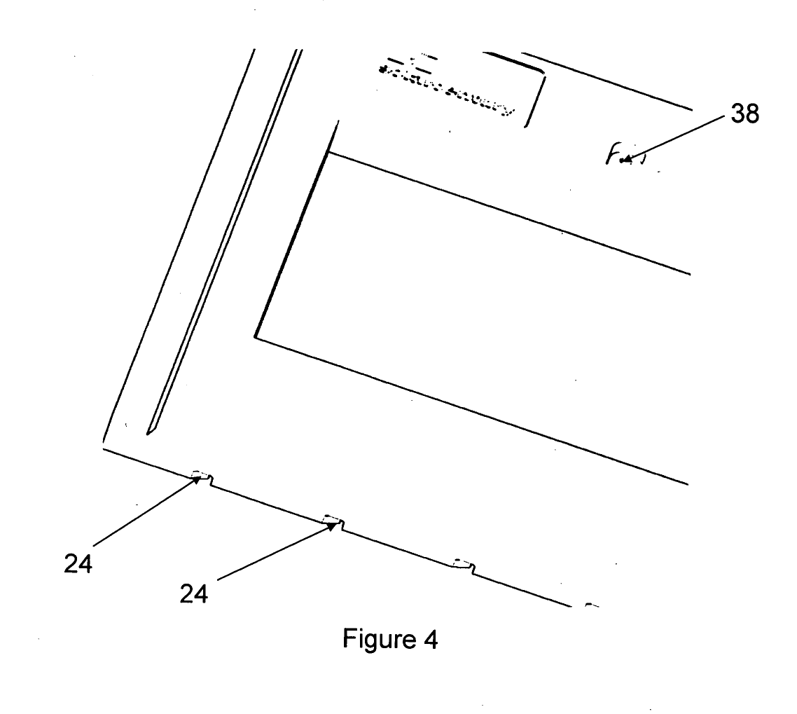

FIG. 4 is a partial view of a tile cover-plate;

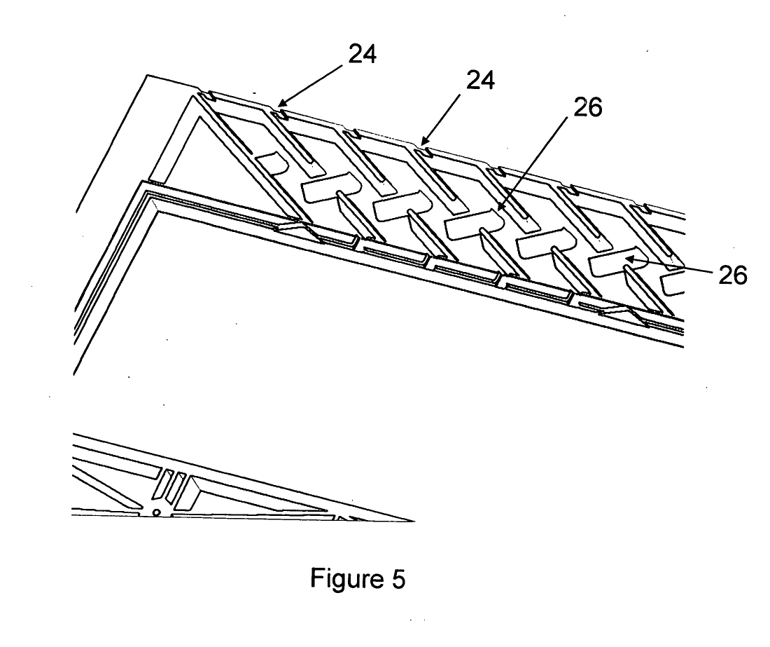

FIG. 5 is an underneath perspective view of a tile cover-plate;

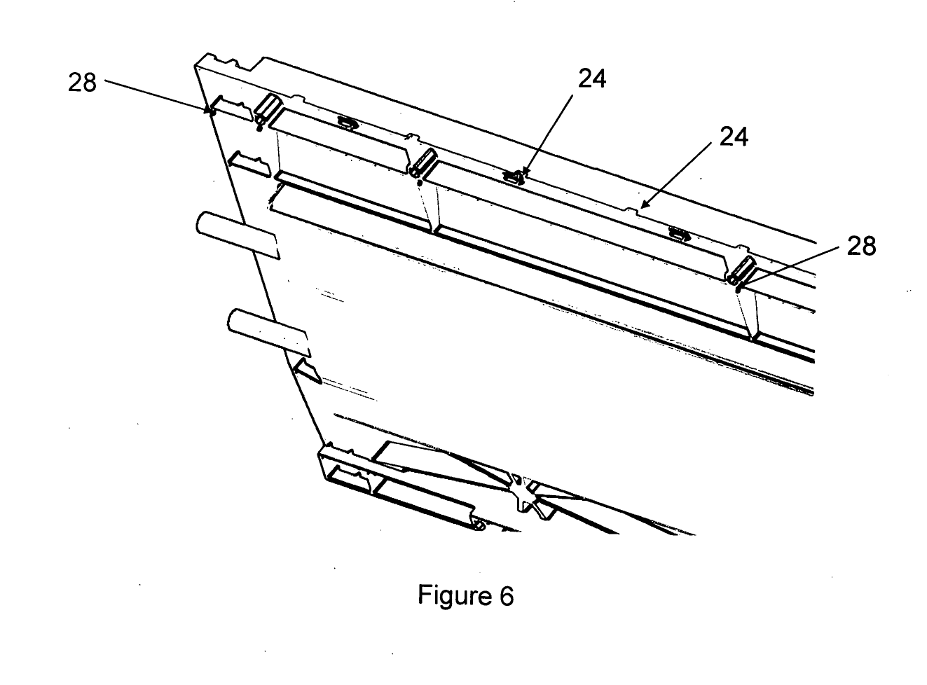

FIG. 6 is an underneath perspective view of an alternative construction of tile;

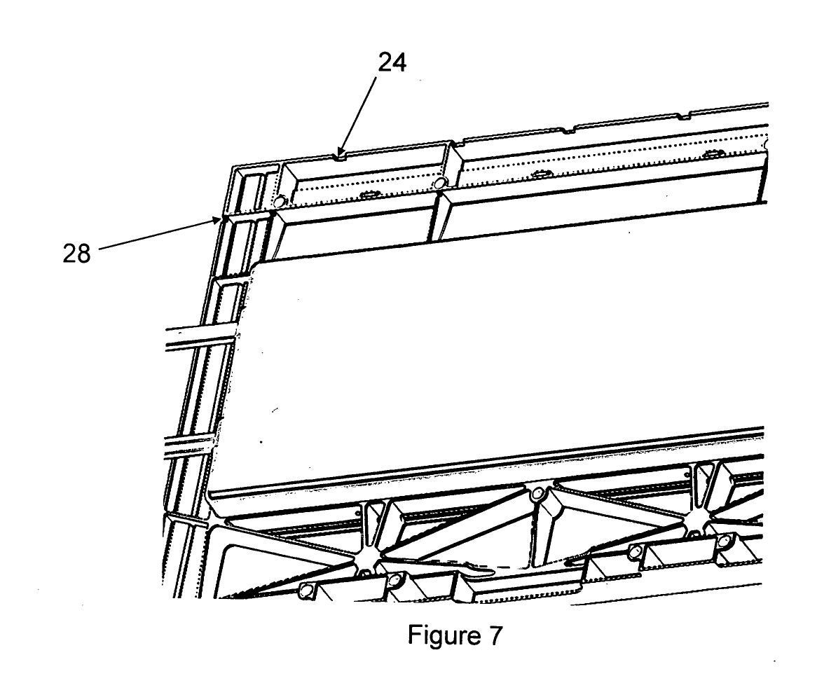

FIG. 7 is a further perspective of the tile of FIG. 6;

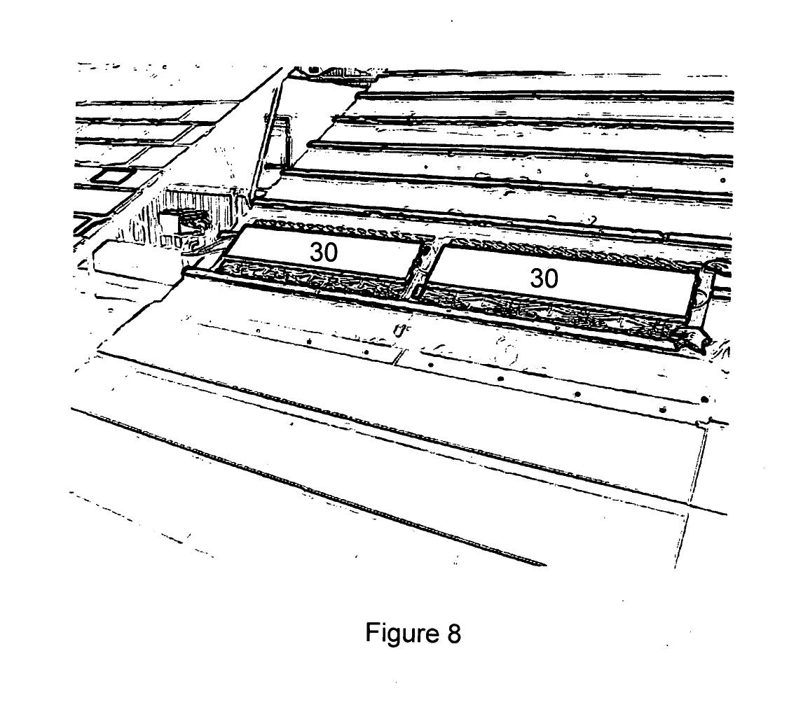

FIG. 8 illustrates a tile installation procedure;

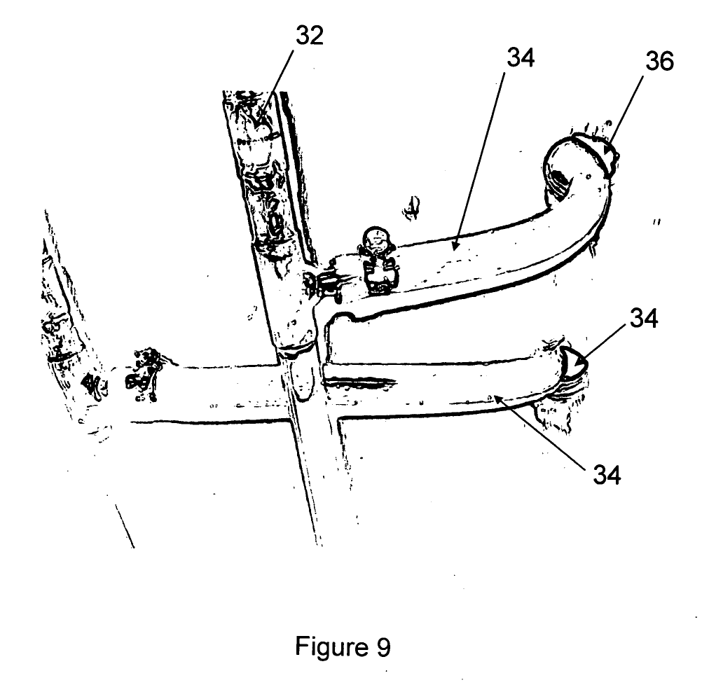

FIG. 9 is an underneath view of a solar thermal manifold system;

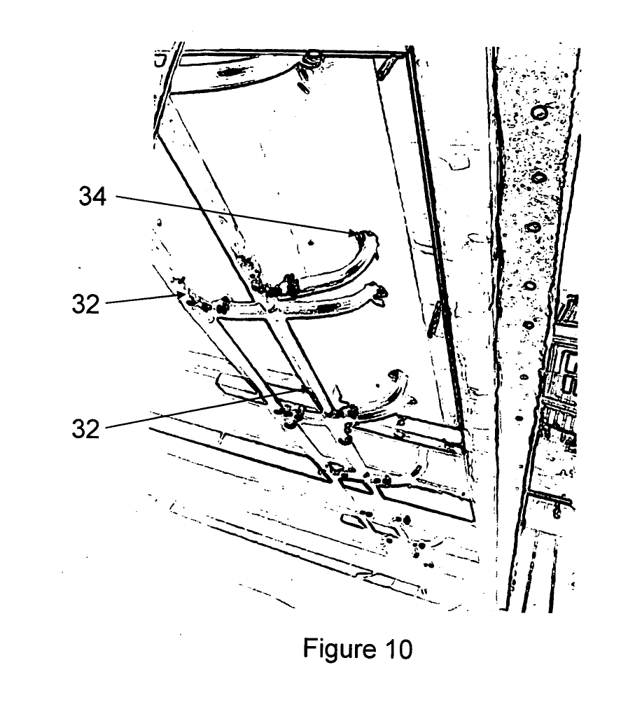

FIG. 10 is a further view of the manifold system of FIG. 9;

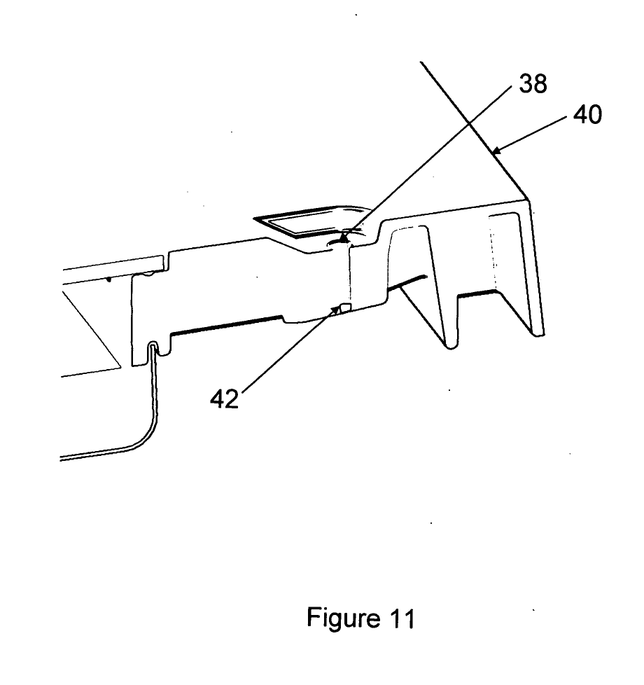

FIG. 11 is a cross-section through a tile illustrating a fixing hole arrangement;

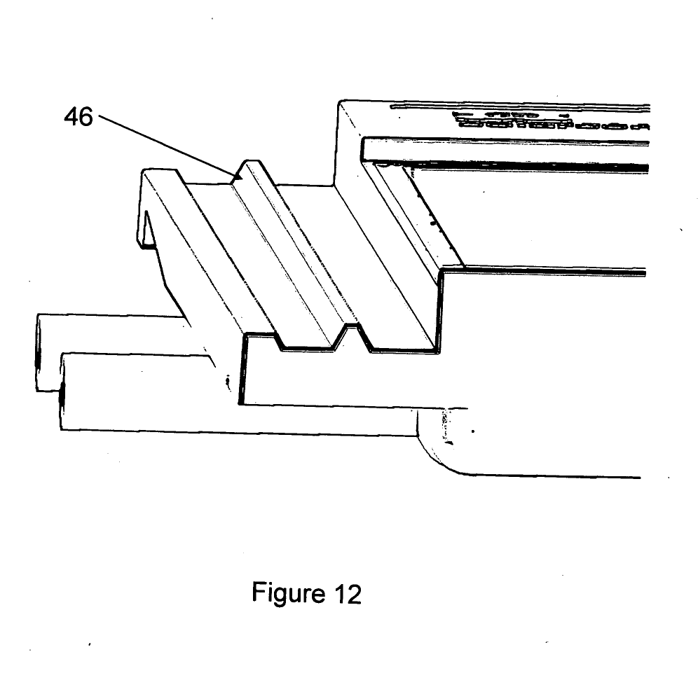

FIG. 12 is a perspective view of a tile interlocking “underlap” feature; and

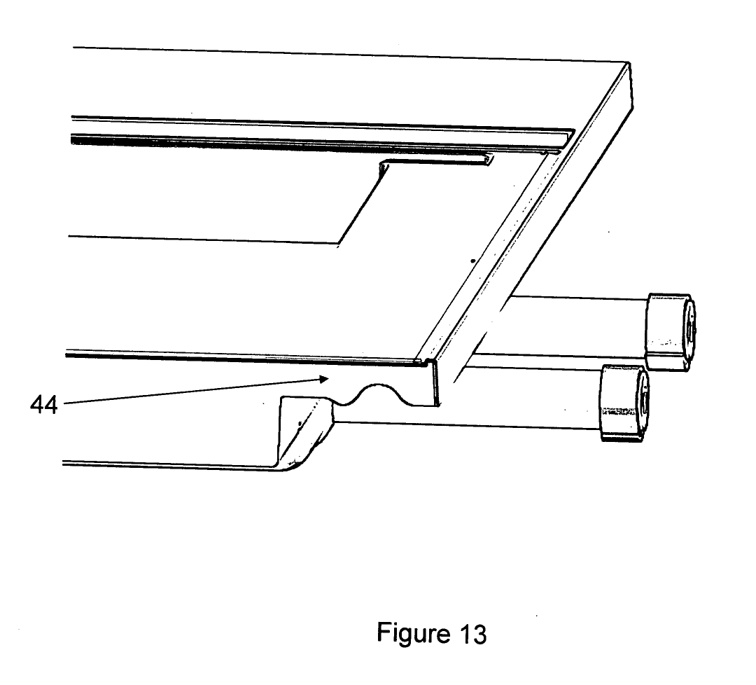

FIG. 13 is a corresponding view of a tile edge “overlap” feature.

Referring to the drawings, FIG. 1 illustrates a series of levels of solar tiles, including four levels of tiles (2) in accordance with the present invention, and two lower levels (4) of conventional photovoltaic tiles below them. FIG. 2 is a more detailed view of one type of solar tile according to the present invention, which comprises a front cover-plate member (6) forming a “frame” for a transparent window (8), and incorporating a trough shaped rear housing (10). A “solar thermal” collector plate (12) is mounted in the trough (10), and incorporates a pair of fluid conduits, (14), on its rear surface.

As illustrated in the Figure, the front cover-plate (6) has a flat upper frame surface (16) so that the adjacent edge of the collector window (8) fits flush against the inner edge of this surface. The lower front surface (18) of the front cover-plate (6) is, however, sloped inwardly from the lower edge (20) of the cover-plate, to the upper edge (22) of the lower face, and the front window (8) overlies this sloping portion, extending right down to the lower edge (20). Consequently, when the tile is installed in a conventional sloping arrangement of the kind shown in FIG. 1, any “shadowing” of the collector plate (12) by the lower edge of the structure, is avoided.

FIG. 3 illustrates the rear surface of collector plate (12) with its two heat exchange conduits (14) which, in the construction shown, are brazed onto the rear surface of the collector plate (12). FIG. 4 illustrates how the lower edge of the front cover-plate is formed with small cut-outs (24) for ventilation and drainage purposes, and FIGS. 5 and 6 illustrate respectively, how reinforcing ribs can be arranged with intervening gaps (26) (FIG. 5) or cut-outs (28) (FIG. 6) so that the drainage and ventilation are not blocked by the respective internal reinforcing structures. This arrangement can also be seen more clearly in FIG. 7.

FIG. 8 shows how the installation of a pair of tiles (30) is simplified, by the arrangement in which they are hinged together by their adjacent edges, so that when they are laid in position on a roof structure, they are correctly aligned relative to one another and also to the adjacent tiles.

FIGS. 9 and 10 illustrate how manifolds (32) connected beneath the roof surface are connected to individual tiles, by means of flexible hoses (34) which extend through the covering. As illustrated, the flexible hoses are simply inserted through suitable apertures (36) in the covering, by the roofer, and can be subsequently connected to the manifolds, by another suitable tradesman such as a plumber or heating engineer.

As illustrated in FIG. 11, fixing holes (38) (also visible in overall views such as FIGS. 2 and 4) are provided near the upper edge (40) of the tile, spaced at suitable intervals, so as to enable the tile to be screwed into the usual fixing battens of the roofing structure. In a preferred arrangement, the fixing hole is moulded with a thin biscuit of material (42) left closing the lower end, which is easily pierced by a fixing screw. However, if that particular fixing hole is not utilised in practice, it will remain closed to prevent the ingress of moisture.

As illustrated in the FIGS. 12 and 13, the left and right side edges of each tile are formed with interlocking features corresponding to those on the side edges of a conventional roof tile. It will be seen from a comparison of these two figures that the features consist of an “overlap” (44) (FIG. 13) and a corresponding “underlap” (46) (FIG. 12) which are provided with co-operating ridges and grooves. The depth and width of the ridges and grooves are so arranged that the tiles will interlock with as many as possible of the corresponding formations on various different manufacturers roof tiles. Thus the grooves (FIG. 12) are made large enough to accommodate the largest possible ridges of an adjacent tile, while the ridges (FIG. 13) are made small enough to fit in the smallest corresponding grooves which are likely to be encountered in practice.

1. A solar roof tile comprising an elongate unit whose length is a multiple of the length of a standard roof tile so that it may be substituted for a corresponding number of such tiles, and comprises an elongate trough-shaped member which is adapted to house a heat exchanger including fluid conduits, and a co-operating cover-plate which includes an aperture adapted to receive a transparent cover for the trough-shaped member, or a photovoltaic collector.

2. A solar roof tile according to claim 1 in which the trough-shaped member and the cover-plate are formed as separate components.

3. A solar roof tile according to claim 1 in which the trough-shaped member and the cover-plate are integrally moulded together.

4. A solar roof tile according to any preceding claim in which the front section of the outer surface of the cover-plate is sloped in towards the trough region, so that when the tile is mounted in a conventional sloping position on a roof, shading of an internal heat exchanger is minimised.

5. A solar roof tile according to any one of claims 1 to 4, further comprising a heat exchanger comprising a pair of roll-bonded aluminium plates defining a pattern of fluid conduits between them.

6. A solar roof tile according to any preceding claim in which the cover-plate comprises a rigid moulding of a plastics material, having front and rear edges formed with downwardly dependent flanges, and ribs on the internal rear surface which act to stiffen the structure.

7. A solar roof tile according to claim 6 in which the free edges of the ribs and flanges are formed with a series of gaps which are so arranged as to allow air to circulate through the internal compartments formed between the tile and an underlying support surface.

8. A solar roof tile according to any preceding claim in which the base of the trough incorporates insulating material.

9. A solar roof tile according to any preceding claim in which the lower edges at least, are formed with a series of mouldings which mimic the overlap joints between adjacent roof tiles, at corresponding spacings.

10. A solar roof tile according to any preceding claim which incorporates fixing locations which are formed as blind holes adapted to be pierced by fixings such as screws, in use.

11. A solar roof tile according to claim 2 in which the cover-plate is adapted to be utilised separately as a photovoltaic collector or a roof window, by mounting a suitable photovoltaic element or a transparent plate in the aperture.

12. A solar roof tile assembly comprising a pair of tiles according to any preceding claim, which are connected together in an end-to-end relationship by a flexible hinge member so that they can be folded together for transportation purposes.

13. A cover-plate for a solar roof tile according to claim 2, the cover plate comprising an elongate unit whose length is a multiple of the length of a standard roof tile so that it may be substituted for a corresponding number of such tiles, an aperture adapted to receive a transparent cover or a photovoltaic collector, downwardly dependent stiffening flanges along the front and rear edges, the side edges carrying respective overlap and underlap protrusions to cooperate with adjacent tiles, and gaps along the free edges of the flanges to provide for air circulation.

14. A cover-plate according to claim 13 further comprising a series of mouldings along the front edge flange at least, which mimic the overlap joints between adjacent roof tiles of normal width.

15. A cover-plate according to claim 14 in which the said mouldings also incorporate at least some of the air circulation gaps.

16. A trough-shaped solar thermal collector housing for a solar roof-tile according to claim 2, comprising a formation of ledges or protrusions along its internal surfaces, adapted to locate a thermal collector plate.

17. A solar roof tile substantially as herein described with reference to the accompanying drawings.
